(19) United States
(12) Patent Application Publication
(10) Pub. No.: US 2009/0193752 A1
(43) Pub. Date: Aug. 6, 2009

(54) Composition and method to treat a termite infestation

(76) Inventor: Andre B. Cox, Tucson, AZ (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 12/315,329

(22) Filed: Dec. 1, 2008

Related U.S. Application Data
(63) Continuation-in-part of application No. 11/273,365, filed on Nov. 14, 2005, now abandoned.
(60) Provisional application No. 60/627,660, filed on Nov. 12, 2004.

(51) Int. Cl. E04G 23/00; A01M 99/00

(52) U.S. Cl. 52/741.3

(57) ABSTRACT

A method is disclosed to treat a termite infestation on building, where that building comprises a structure and a foundation, where the foundation comprises an exposed portion in contact with soil and extending upwardly to the structure, and wherein one or more termite tunnels are disposed on that exposed portion. The method removes any existing termite tunnels from the exposed portion of the foundation. The method further disposes a polymeric material horizontally on the exposed portion of the foundation, and over any former termite tunnel locations, where that polymeric material comprises a surface roughness Amplitude Parameter Ra of 32 microinches or less.

### CROSS REFERENCE TO RELATED APPLICATIONS

This application is a Continuation In Part claiming priority from a U.S. Application having Ser. No. 11/273,365, which claimed priority from a U.S. Provisional Application having Ser. No. 60/627,660.

### FIELD OF THE INVENTION

The invention relates to a composition, and a method using that composition, to treat or deter a termite infestation.

### BACKGROUND OF THE INVENTION

Subterranean termites present a serious threat to structures, and particularly residential structures, throughout most of the United States and in many parts of the world. One of the most widely used techniques to combat termite infestation is the application of chemical agents to the ground under and around the structure. In a typical preconstruction treatment situation, a liquid form termiticide is sprayed at specified concentrations and volumes directly onto the compacted soil immediately before the concrete slab is poured, creating a horizontal barrier between any subterranean nests and the underside of the slab. Additional barriers are created by boring holes into the soil at specified intervals (often 18 inches) or by digging trenches around the structure and spraying termiticide into the openings as well as mixing termiticide with the backfill soil. If treatment is required to control active infestation that occurs after construction, techniques include drilling holes in infested walls and injecting liquid or powdered termiticides between the walls, boring holes in the floor slab at spaced intervals and injecting liquid termiticides into the soil, and trenching around the base of the structure and applying termiticides as in pretreatment.

An insecticide is a pesticide formulated for use against insects in all developmental forms. A termiticide is a pesticide formulated for use against termites in all developmental forms. In the past, conventional insecticides such as the chlorinated hydrocarbons known as chlordane, DDT, aldrin, dieldrin and BHC could be effectively used to poison the soil so that transiting termites would be killed. These chemicals also remained effective in the ground for many years. Unfortunately, their effectiveness as poisoning agents extended beyond the targeted pests, and environmental concerns have resulted in prohibition of the use of any of these agents for termite treatment. Chlordane was the last such chemical available for either home or professional use, and that was banned by the United States Environmental Protection Agency in 1987.

The pest control industry has been forced to adopt a less potent class of chemical poisons for termite pre-treatment and infestation interdiction. Currently approved by the Environmental Protection Agency are chlorpyrifos (sold under the name DURSBAN TC), cypermethrin (sold as DEMON TC), fenvalerate (sold as TRIBUTE), and permethrin (sold as DRAGNET and as PRELUDE). These chemicals are generally applied in the same manner as their predecessor chlorinated hydrocarbons, namely, spraying beneath a slab or other foundation to form a horizontal barrier and injection through holes or a trench to form a vertical barrier or “curtain” through which termites cannot penetrate without being killed. They are also used for infestation control.

Unfortunately, the very characteristics that make them acceptable from an environmental standpoint (low toxicity and eventual degrading into non-toxic components) render them less effective in long term termite control. One of the most common termiticides, and the only one available to consumers who are not licensed pest control operators, is chlorpyrifos, an organophosphate that is available in emulsifiable concentrate, dust, flowable, pellet, spray, granular and wettable powder formulations. The chemical adsorbs well to soil particles, is not readily soluble in water, and has a half life of 2 weeks to a year, but most commonly 60 to 120 days. Chlorpyrifos acts as a cholinesterase inhibitor, interfering with the proper working of the nervous system. It works as a contact poison, but also as a stomach poison. A conventional termite barrier laid down by spraying chlorpyrifos is expected to kill termites that pass through it, and to generate secondary kills in the nest when the carcasses of poisoned termites are carried to the nest and cannibalized. If that chemical termite barrier is disturbed during construction, landscaping, and the like, then that barrier may no longer be effective.

In addition, the half life of the chemical barrier virtually assures that the efficacy of the chemical will end before that of the structure. Based on findings of a study of the residual effects of chlorpyrifos on the human nervous system and a revised risk assessment, the Environmental Protection Agency in 2000 banned use of the chemical in post-construction infestation control and dramatically reduced the allowable concentrations in residential pre-treatment, with a 4-year program to phase out chlorpyrifos altogether.

To enhance the effectiveness of termiticidal compounds, both before and after the banning of chlorinated hydrocarbons, the chemicals were combined into termite “baits” consisting of the poison and an attractive termite food, namely, some form of cellulose. The objective is to induce the termites to ingest the poisoned food and return with it to the nest, where food is normally regurgitated and shared with the rest of the colony. Two early examples are U.S. Pat. No. 3,858,346 (Bailey) and U.S. Pat. No. 4,582,901 (Prestwich). Bailey disclosed impregnation of building timbers with hexachlorocyclopentadiene dimer in an organic solvent such as benzene or carbon tetrachloride as the termiticide, and also spreading bait comprising the same poison added to a termite-attracting carbohydrate carrier such as citrus pulp, sawdust and decaying wood. Prestwich discloses modifying the chemical composition of cellulose to include fluorinated ester moieties. The modified cellulose may be formed into bait blocks or injectable dust for placement in areas to be protected or treated.

In more recent, environmentally safer approaches, U.S. Pat. No. 5,564,222 (Brody) discloses impregnating cellulose items, such as wooden or cardboard stakes, balls or pellets with a water soluble borate salt. The termites are attracted to and consume the cellulose and the borate salt functions as a slow-acting termiticide. U.S. Pat. No. 5,573,760 (Thorne, et al.) discloses using a termite monitor in the form of a perforated cartridge containing a cellulose-rich composition, water and an exogenous nitrogen source. Once foraging termites encounter the desirable food source, they recruit others, and a tunnel to the device is constructed. This allows early detection of termites near a protected structure, as the bait is a more desirable food than the structure. Once activity is identified, the cartridge can be removed and replaced with a similar cartridge containing the same food composition, but laced with a slow-acting termiticide.

The bait approach as previously implemented has at several disadvantages. First, there are necessarily gaps between the bait modules, leaving the possibility that termites may simply miss the bait, tunneling between the modules and reaching and infesting the protected structure. Current protection standards require a horizontal barrier and vertical curtain without any gaps. Second, placing of the bait modules, whether spikes, buried balls, pellets or dust, is time consuming, labor intensive and consequently expensive. The closer together the bait modules, the more work and expense involved.

### SUMMARY OF THE INVENTION

There is a need for a termite barrier that does not employ insecticides, termiticides, or other environmentally hazardous substances, and yet does not substantially increase the complexity or cost of construction. Applicant's invention provides a method to treat or deter a termite infestation, wherein that method does not utilize a termiticide or an insecticide.

Applicants' invention comprises a method to treat or deter a termite infestation in a building comprising a structure and a foundation, where the foundation comprises an exposed portion in contact with soil and extending upwardly to the structure, and wherein one or more termite tunnels are disposed over that exposed portion. The method removes any existing termite tunnels from the exposed portion of the foundation. The method further disposes a polymeric material horizontally against the exposed portion of the foundation, and over any former termite tunnel locations, where that polymeric material does not comprise a cloth tape, a cloth tape comprising a polyurethane coating, or any insecticides and/or termiticides. In certain embodiments, Applicant's polymeric material comprises a film formed from one or more polymeric materials, wherein that film comprises a surface roughness Amplitude Parameter Ra of 32 microinches or less. In certain embodiments, Applicant's polymeric material comprises a film formed from one or more polymeric materials, wherein that film does not comprise any pressure sensitive adhesives or uncured adhesives.

### BRIEF DESCRIPTION OF THE DRAWINGS

FIG. 1 shows a side view of a portion of a building which includes a foundation in contact with the earth and a structure disposed on top of that foundation and three termite tunnels extending upwardly from the earth and crossing the foundation to enter the structure;

FIG. 2 shows a side view of the building of FIG. 1 where an epoxy coating is disposed over a portion of the foundation;

FIG. 3 shows the building of FIG. 2 wherein a termite tunnel extends upwardly from the earth across an uncoated portion of the foundation;

FIG. 4A shows a side view of a portion a building which includes a foundation in contact with the earth and a structure disposed on top of that foundation and two termite tunnels extending upwardly from the earth and crossing the foundation to enter the structure;

FIG. 4B shows the building of FIG. 4A wherein the termite tunnels have been mechanically destroyed;

FIG. 4C shows an epoxy coating disposed from the earth upwardly to the structure and across the portions of the foundation previously encumbered with the termite tunnels wherein no termite tunnels were observed to be rebuilt across those treated portions;

FIG. 5A shows a side view of a portion a building which includes a foundation in contact with the earth and a structure disposed on top of that foundation and two termite tunnels extending upwardly from the earth and crossing the foundation to enter the structure;

FIG. 5B shows the building of FIG. 5A wherein the termite tunnels have been mechanically destroyed;

FIG. 5C shows the building of FIG. 5B wherein both termite tunnels have been rebuilt;

FIG. 6 shows the building of FIG. 5C after both once-rebuilt termite tunnels were mechanically destroyed and wherein a first portion of the foundation previously encumbered with a first tunnel and a first rebuilt tunnel has been treated with an epoxy coating extending upwardly about 6 inches from the earth, and a second uncoated portion of the foundation previously encumbered with a first tunnel and a first rebuilt tunnel;

FIG. 7 shows the building of FIG. 6 wherein a second-rebuilt tunnel is observed extending across the uncoated portion of the foundation and wherein no rebuilt tunnels are observed crossing the treated portion of the foundation; and

FIG. 8 shows another embodiment of Applicant's partial coating method, wherein the partial coating comprises a series of diagonal treated sections;

FIG. 9A shows a side view of a portion a building which includes a foundation in contact with the earth and a structure disposed on top of that foundation and two termite tunnels extending upwardly from the earth and crossing the foundation to enter the structure;

FIG. 9B shows the building of FIG. 9A wherein the termite tunnels have been mechanically destroyed;

FIG. 9C shows the building of FIG. 9B wherein a polyvinylchloride film has been disposed over the former termite tunnel locations;

FIG. 10A shows a side view of a portion a building which includes a foundation in contact with the earth and a structure disposed on top of that foundation and two termite tunnels extending upwardly from the earth and crossing the foundation to enter the structure;

FIG. 10B shows the building of FIG. 10A wherein the termite tunnels have been mechanically destroyed;

FIG. 10C shows the building of FIG. 10B wherein cloth tapes have been disposed over the former termite tunnel locations;

FIG. 11A shows a side view of a portion a building which includes a foundation in contact with the earth and a structure disposed on top of that foundation and two termite tunnels extending upwardly from the earth and crossing the foundation to enter the structure;

FIG. 11B shows the building of FIG. 11A wherein the termite tunnels have been mechanically destroyed;

FIG. 11C shows the building of FIG. 5B wherein cloth tapes comprising a polyurethane coating have been disposed over the former termite tunnel locations;

FIG. 12A shows a side view of a polymeric film disposed across a portion of a foundation;

FIG. 12B shows use of an adhesive bonding the film of FIG. 12A to a portion of a foundation.

### DETAILED DESCRIPTION OF THE PREFERRED EMBODIMENTS

Applicants' invention is described in preferred embodiments in the following description with reference to the Figures, in which like numbers represent the same or similar elements. The invention will be described in reference to a structure comprising a foundation having cement support structure and a wood framed dwelling disposed thereon. The following description of Applicant's termite barrier is not meant, however, to limit Applicant's invention to any particular structure, i.e. residential, commercial, industrial, or to any particular construction method. Rather, Applicants' invention can be utilized in a wide variety of structures built using a wide variety of construction methods.

In certain embodiments, Applicants' method does not utilize any poisons and/or toxins. In these embodiments, a homeowner having no special skills, equipment, certifications, or experience, can readily use Applicants' termite barrier method. In addition to comprising a termite barrier, Applicants' method also effectively seals the transition section between foundation and structure to invasion by most insects.

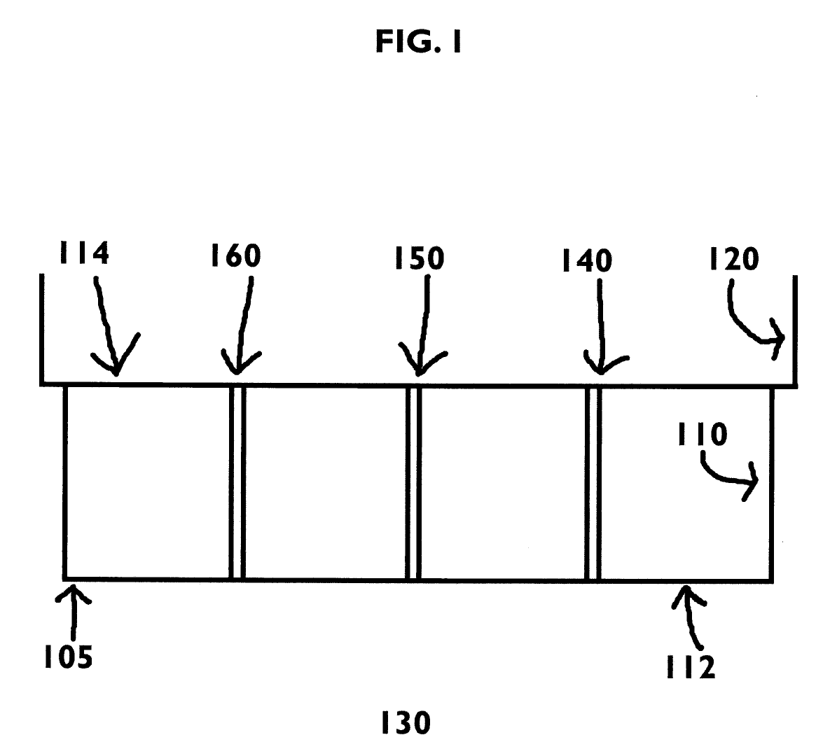

FIG. 1 shows a portion of a building which includes a foundation 110 and structure 120 disposed thereon. By “foundation,” Applicant means a support structure comprising, for example and without limitation, cinder blocks, poured cement, brick, wood, and combinations thereof. In certain embodiments, structure 120 comprises wood in optional combination with a wide variety of other materials, including without limitation natural materials, synthetic materials, and combinations thereof.

As those skilled in the art will appreciate, foundation 110 is disposed on, and in certain embodiments, in real property 130, i.e. soil. In certain embodiments, foundation 110 extends beneath the top portion of property 130 and into subsurface portions of that property. In certain embodiments, property 130 comprises rocks and soil. In certain embodiments, property 130 further includes vegetation, such as for example grass, shrubs, trees, cactus, and the like. As those skilled in the art will appreciate, the portion of the foundation that extends upwardly from the soil to the structure is sometimes referred to as a “stemwall.”

In the illustrated embodiment of FIG. 1, three termite “tunnels,” namely tunnels 140, 150, and 160, extend from the surface 112 of property 130 upwardly across foundation 110, and into structure 120. Such termite tunnels are sometimes referred to as “shelter tubes.” As those skilled in the art will appreciate, termite tunnels are typically formed from mud. As those skilled in the art will further appreciate, the mud comprising a termite tunnel also includes one or more adhesive materials supplied by the termites, where those one or more adhesives bind the mud and also adhere the mud tunnel to foundation 110.

The following Examples are presented to further illustrate to persons skilled in the art how to make and use the invention and to identify a presently preferred embodiment thereof. These examples are not intended as a limitation, however, upon the scope of the invention, which is defined only by the appended claims.

### Example I

In this Example I, Applicant utilized his method to effectively treat a building suffering from a termite infestation. Referring again to FIG. 1, building 105 includes foundation 110 and structure 120. Before beginning the study of Example 1, three termite tunnels, namely tunnels 140, 150, and 160, were observed.

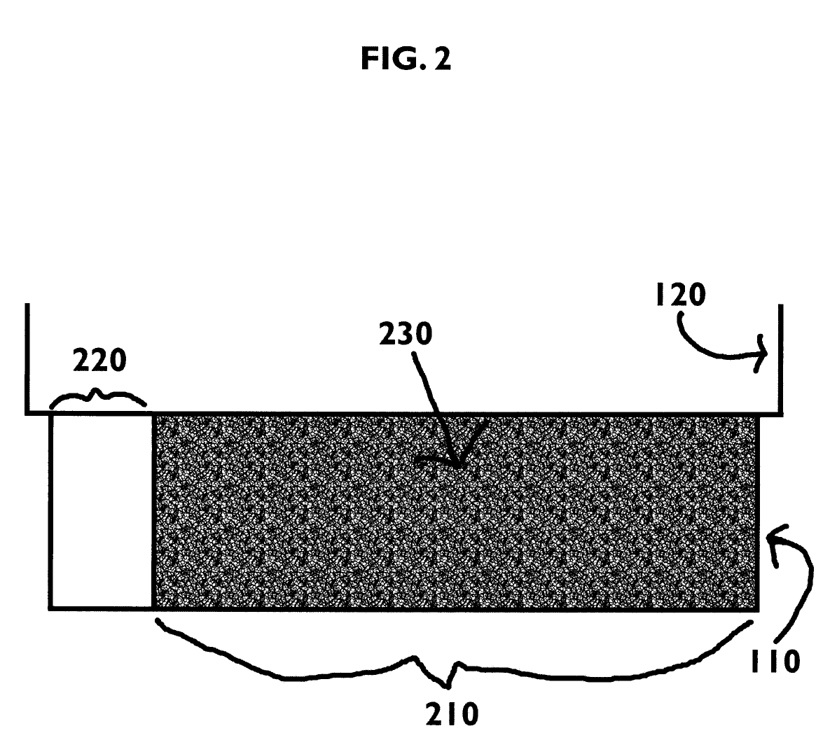

Referring to FIG. 2, on day 1 of the study termite tunnels 140, 150, and 160, were removed from foundation 110 by mechanically destroying those tunnels. After such physical destruction, an epoxy coating 230 was disposed on portion 210 of foundation 110. Portion 220 of foundation 110 was left untreated. In this study, epoxy coating 230 comprised a two part epoxy system sold in commerce under the tradename 2000 RESIN by Resin Research, Inc.

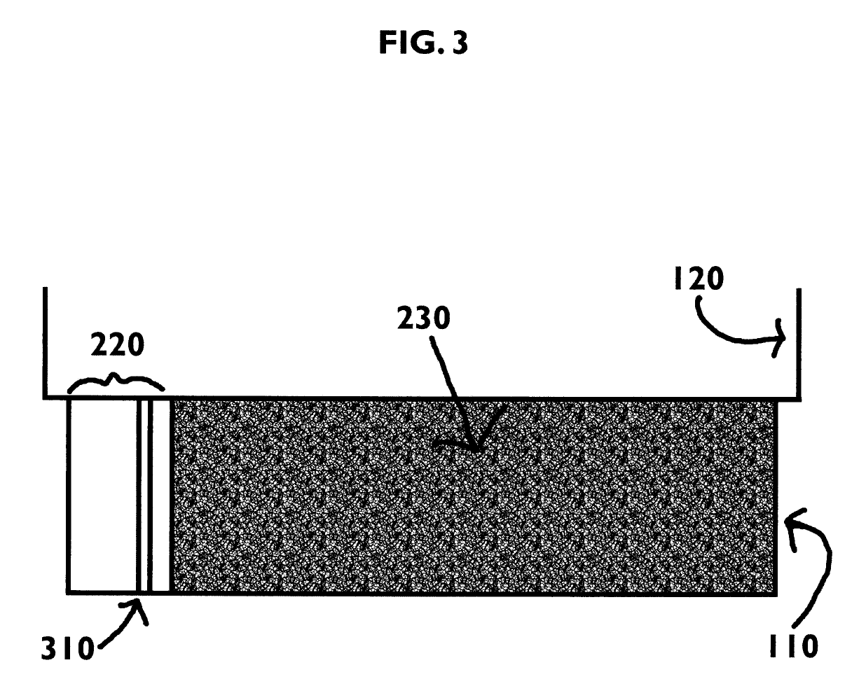

Referring now to FIG. 3, on the morning of day 2 of the study, termite tunnel 310 was observed. That termite tunnel had been rebuilt overnight. No termite tunnels were observed on treated portion 210 of foundation 110. On day 14 of the study, no termite tunnels were observed on treated portion 230.

### Example II

In this Example II, Applicant again utilized his method to effectively treat a building suffering from a termite infestation. One day of Applicants' second study, five (5) termite tunnels disposed on a foundation were physically destroyed and an epoxy coating 230 was manually applied to that foundation. Eighteen (18) months later no termite tunnels were observed on that treated foundation.

### Example III

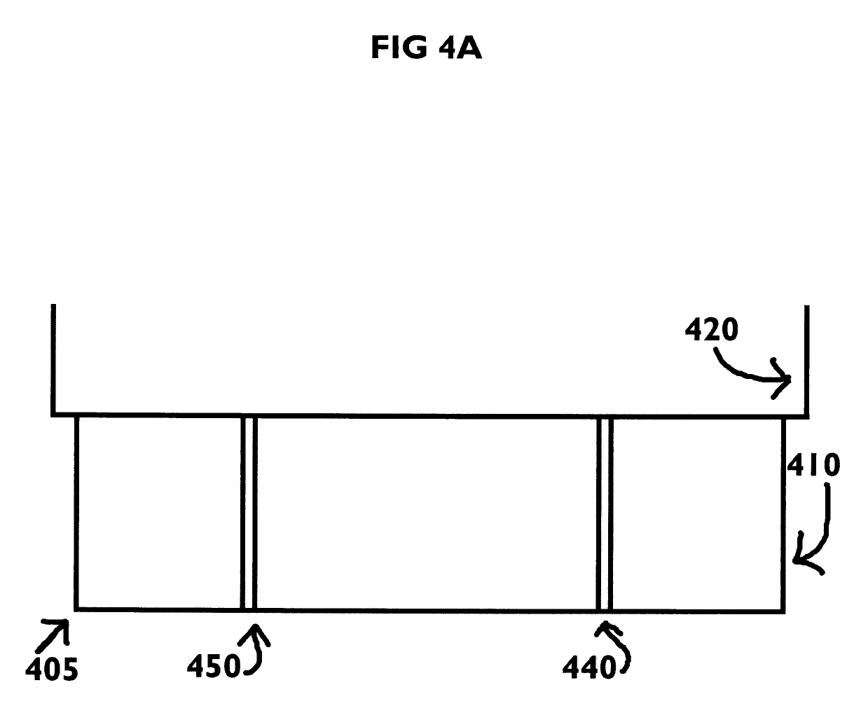

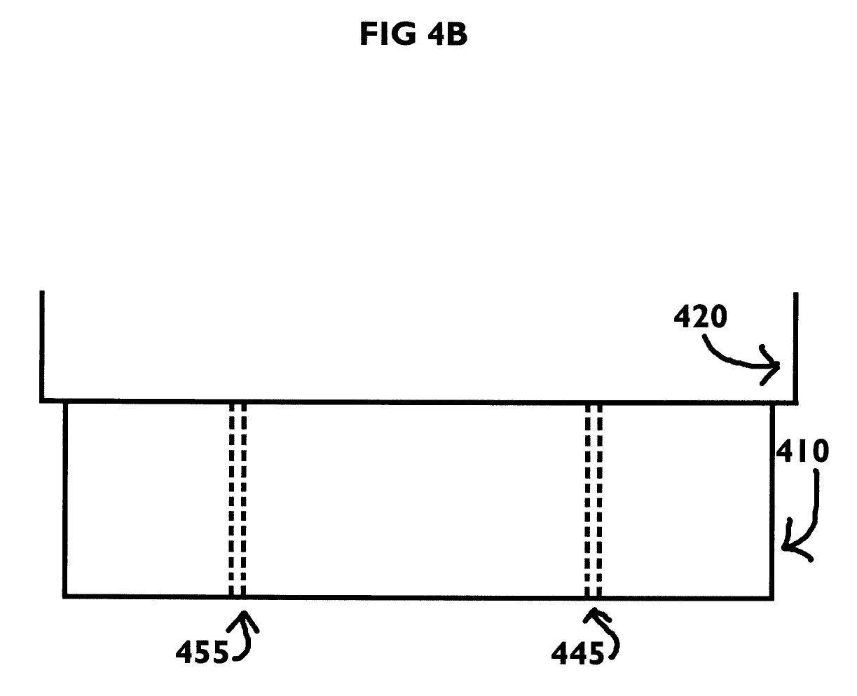

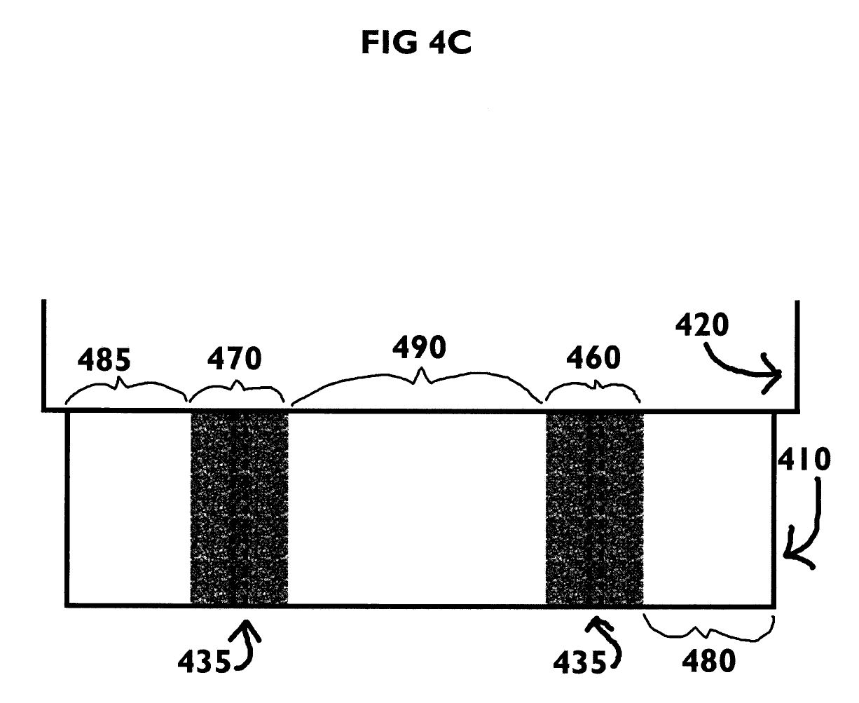

In this Example III, Applicant again utilized his method to effectively treat a building suffering from a termite infestation. Referring to FIG. 4A, building 405 includes foundation 410 and structure 420. Before beginning the study of Example III, two termite tunnels, namely tunnels 440 and 450 were observed.

Referring to FIG. 4B, on day 1 of the study termite tunnels 440 and 450 were removed from foundation 410 by mechanically destroying those tunnels. Portion 445 comprises that portion of foundation 410 onto which termite tunnel 440 was previously disposed. Portion 455 comprises that portion of foundation 410 onto which termite tunnel 450 was previously disposed.

Referring now to FIG. 4C, after the physical destruction of tunnels 440 and 450, an epoxy coating 435 was disposed on portion 460 and 470 of foundation 410. The remaining portions of foundation 110 were left untreated. In this study, epoxy coating 435 comprised a two part epoxy system sold in commerce under the tradename 2000 RESIN by Resin Research, Inc. Over a period of more than thirty (30) months, no termite tunnels were observed on treated portions 460 or 470. In addition, over those thirty months no termite tunnels were observed on untreated portions 480, 485, and 490.

### Example IV

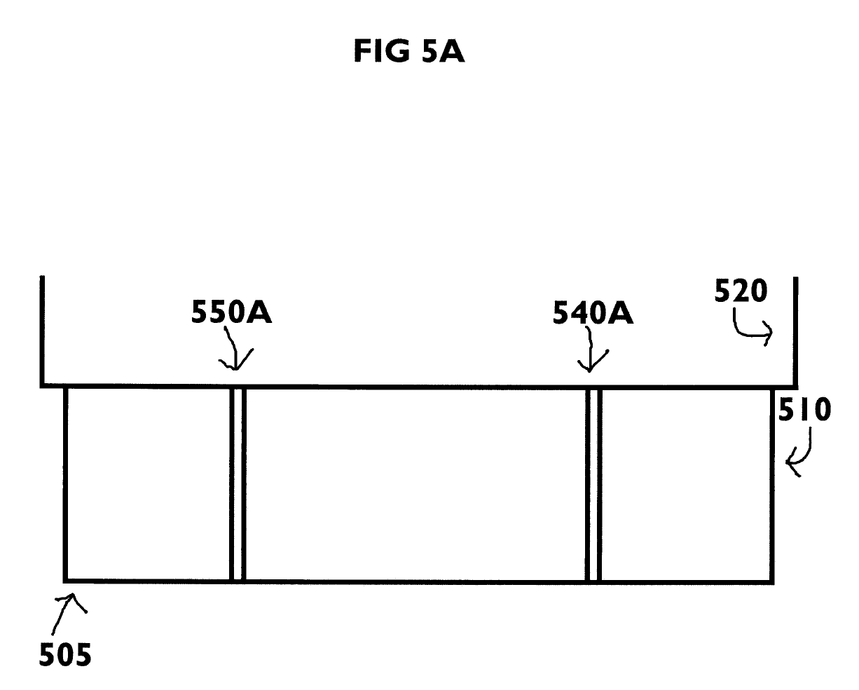

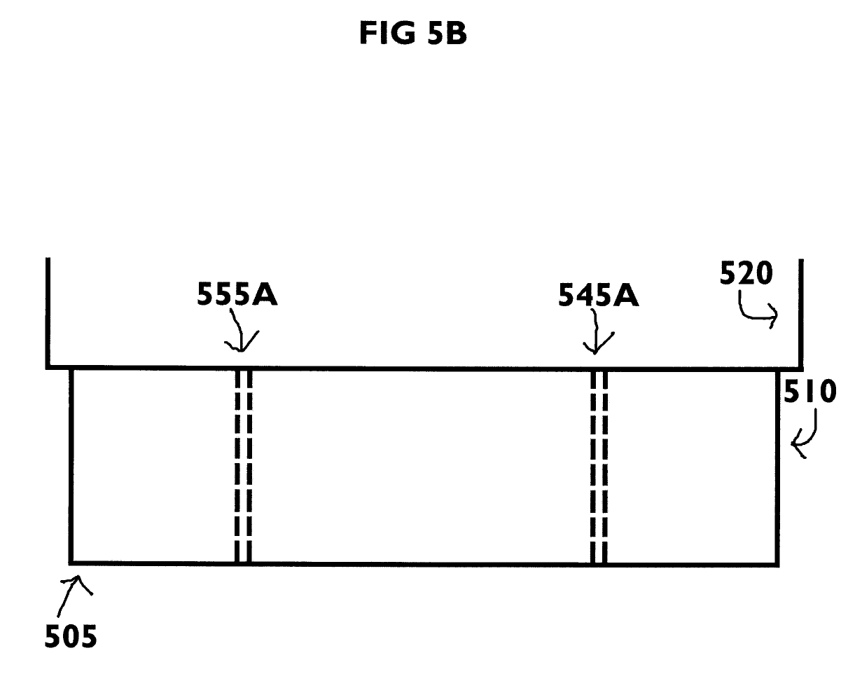

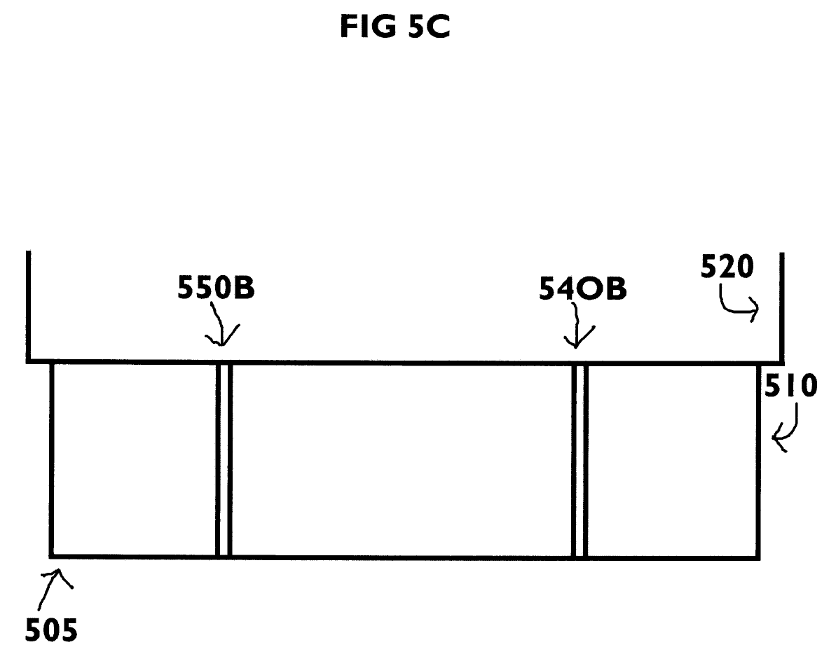

In this Example IV, Applicant again utilized his method to effectively treat a building suffering from a termite infestation. Referring to FIG. 5A, building 505 includes foundation 510 and structure 520. Before beginning the study of Example IV, two termite tunnels, namely tunnels 540a and 550a were observed.

Referring to FIG. 5B, on day 1 of the study termite tunnels 540a and 550a were removed from foundation 510 by mechanically destroying those tunnels. Portion 545a comprises that portion of foundation 510 onto which termite tunnel 440a was previously disposed. Portion 555a comprises that portion of foundation 510 onto which termite tunnel 550a was previously disposed.

Referring now to FIG. 5C, within about one day termite tunnels 540b and 550b were observed in about the same locations as the former tunnels 540a and 550a, respectively. Once again, tunnels 540b and 550b were mechanically destroyed.

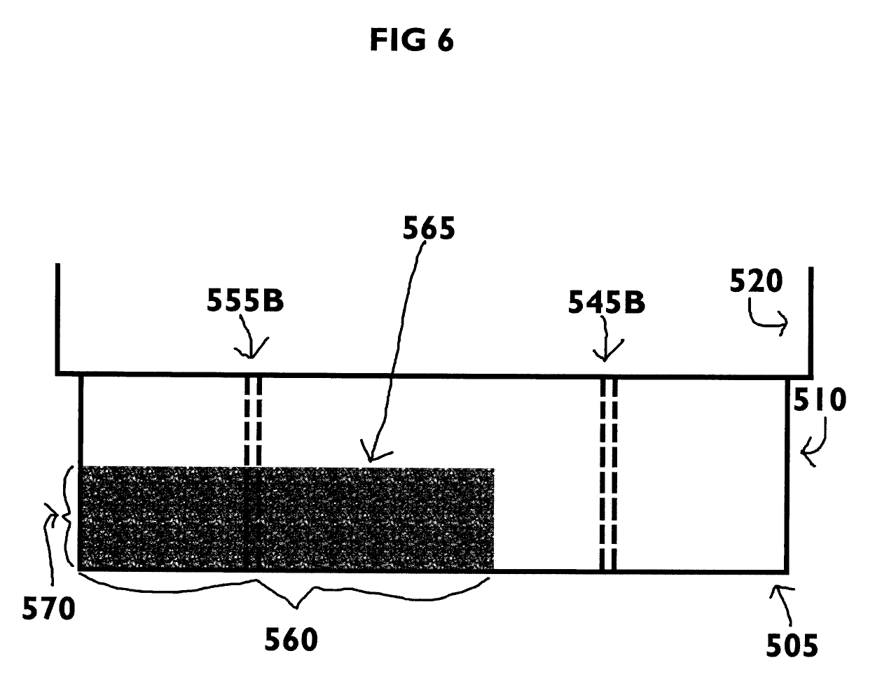

Referring now to FIG. 6, epoxy coating 565 was disposed over portion 560 of foundation 510, where portion 560 had a height 570 of about 6 inches. The portion of foundation 510 above portion 560 was not coated with epoxy coating 565.

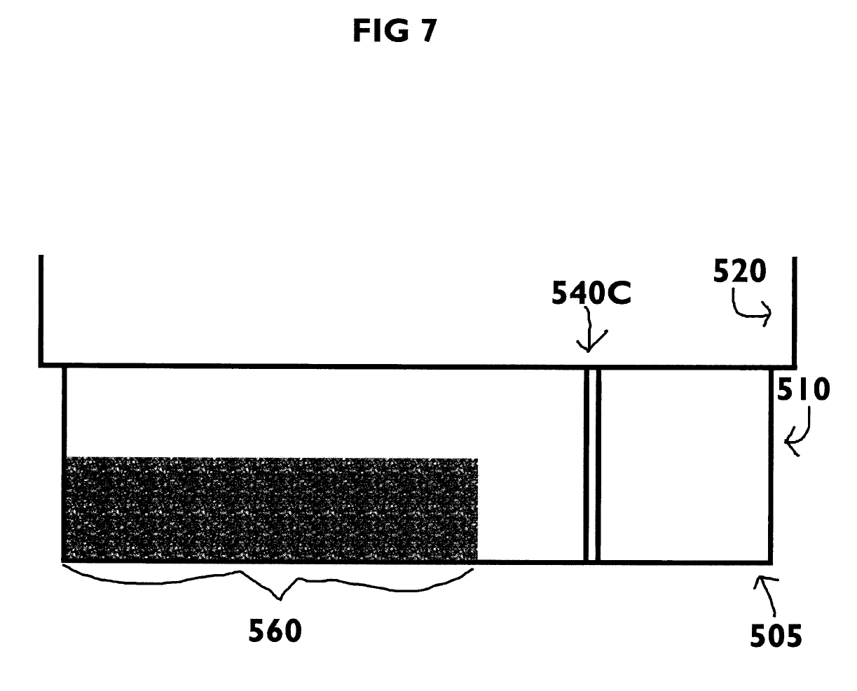

Referring to FIG. 7, after one day of applying coating 565 to portion 560, tunnel 540c was observed in about the location as previous tunnels 540a and 540b. After three (3) years, no termite tunnels were observed crossing portion 560 of foundation 510. This Example IV shows that disposing an epoxy coating across a foundation where the coated section is about 6 inches or more in height resists subsequent termite invasion across that coated portion.

Applicant's termite barrier treatment of Examples I, II, III, and IV, creates a hard, solid and slippery coating over the foundation and seals off access to the wooden construction materials. Applicant has found that the one or more adhesive materials that termites use to affix the mud for their tunnels does not adhere to Applicants' termite barrier treatment. In addition, Applicant has found that his treated foundation portions are rendered too slippery for termites to crawl over without falling off.

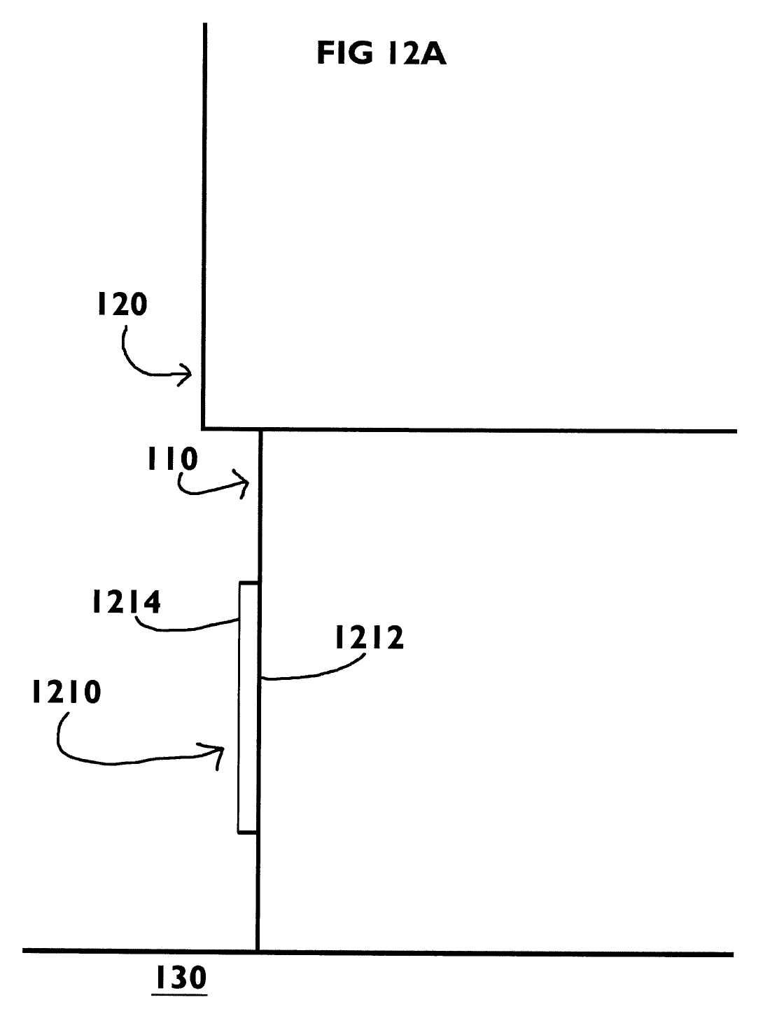

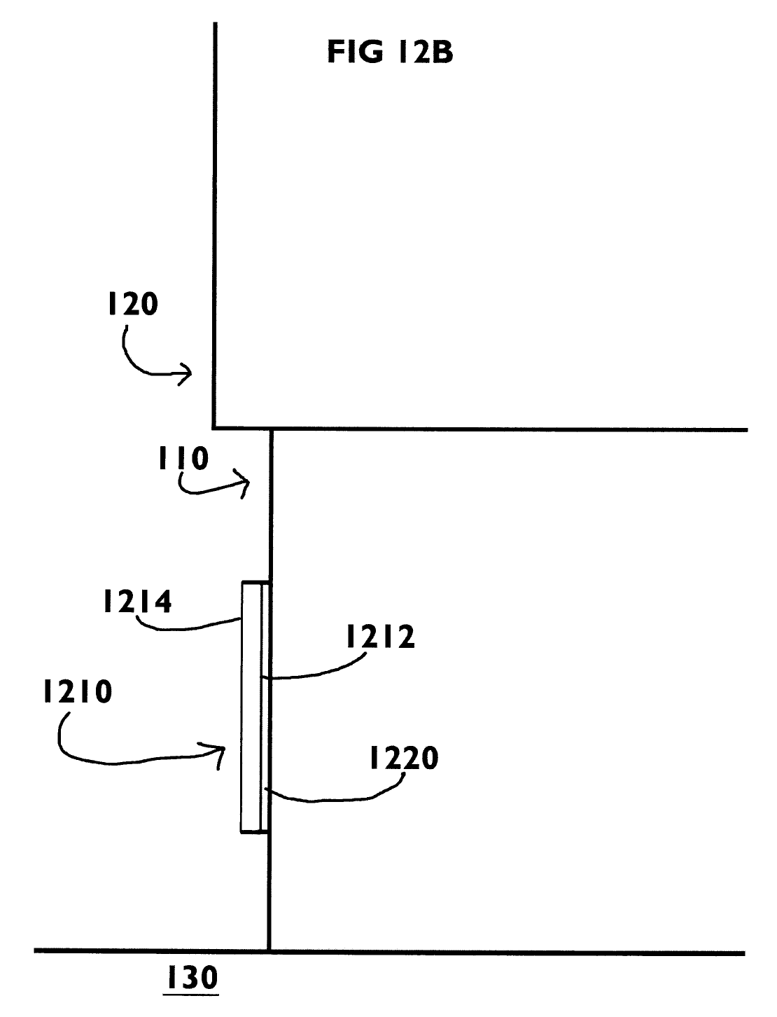

Referring now to FIG. 12A, a band of polymeric material 1210 is shown disposed across a portion of foundation 110. Polymeric material 1210 comprises a first surface, i.e. a contact surface, 1212 in contact with foundation 110, and an opposing second surface, i.e. an exterior surface, wherein that exterior surface is not in contact with foundation 110. FIG. 12B shows an adhesive 1220 bonding the contact surface 1212 to a portion of foundation 110.

For a termite to transition from soil 130 to structure 120, that termite must cross exterior surface 1214. Applicant has found that a “smooth” exterior surface 1214 deters termite movement from soil 130 to structure 120. As those skilled in the art will appreciate, a smooth surface comprises the absence of a rough surface.

Applicant's polymeric material 1210 does not comprise a pressure sensitive adhesive (“PSA”), uncured adhesive, or any sort of “sticky” substance, disposed on exterior surface 1214. Applicant has found that use of any such PSAs, uncured adhesives, and/or sticky substances, on exterior surface 1214 causes airborne particulates, including but not limited to dust, dirt, soot, and the like, to discolor polymeric material 1210. In addition, such entrapped materials form a rough surface over which termites can cross. Moreover, such PSAs, uncured adhesives, and/or sticky substances, disposed on exterior surface 1214 will over time dry/cure to form a rough surface that termites can easily cross.

Roughness is a measure of the texture of a surface. Surface roughness can be quantified by the vertical deviations of a real surface from its ideal form. If these deviations are large, the surface is rough; if they are small the surface is smooth. Roughness is typically considered to be the high frequency, short wavelength component of a measured surface. Roughness can be measured using contact or non-contact methods. Contact methods involve dragging a measurement stylus across the surface; these instruments include profilometers. Non-contact methods include interferometry, confocal microscopy, electrical capacitance and electron microscopy.

A Roughness parameter can be calculated using a formula for describing a surface. More specifically, an Amplitude Parameter Ra is based on the vertical deviations of a measured roughness profile from a mean line.

$${R}_{a} = \frac{1}{n} {\sum }_{i = 1}^{n} \vert {y}_{i} \vert$$

Applicant has found that polymeric materials comprising an exterior surface having an Amplitude Parameter Ra of 32 microinches is preferable.

Applicant has found that as the Amplitude Parameter for a polymeric material is lowered from 32 microinches, that polymeric material becomes an even better termite barrier. As those skilled in the art will appreciate, as the Amplitude Parameter for a polymeric material is lowered from 32 microinches, the cost of that polymeric material increases. Depending upon the local environment, climate, and prevalence of termites, the cost effectiveness of purchasing and using a polymeric material having a surface roughness Amplitude Parameter of 32, or 16, or 8, or 4, or 2, varies.

In certain embodiments, Applicant's polymeric material comprises an exterior surface comprising an Amplitude Parameter Ra of 32 microinches or less. In certain embodiments, Applicant's polymeric material comprises an Amplitude Parameter Ra of 16 microinches or less. In certain embodiments, Applicant's polymeric material comprises an Amplitude Parameter Ra of 8 microinches or less. In certain embodiments, Applicant's polymeric material comprises an Amplitude Parameter Ra of 4 microinches or less. In certain embodiments, Applicant's polymeric material comprises an Amplitude Parameter Ra of 2 microinches or less.

In certain embodiments, polymeric material 1210 comprises a polymeric film having a thickness between about 0.5 mil to about 5 mil. In certain embodiments, polymeric material 1210 comprises a polymeric film having a thickness between about 0.5 mil to about 5 mil, wherein that polymeric film does not comprise an added insecticide. In certain embodiments, polymeric material 1210 comprises a polymeric film having a thickness between about 0.5 mil to about 5 mil, wherein that polymeric film does not comprise an added termiticide.

Applicant has found that films formed from a crystalline polymer comprises a higher surface roughness than films formed from amorphous polymers. In certain embodiments, Applicant's polymeric material comprises a film formed from poly(methyl methacrylate). In certain embodiments, Applicant's polymeric material comprises a film formed from low density polyethylene. In certain embodiments, Applicant's polymeric material comprises a film formed from atactic polystyrene. In certain embodiments, Applicant's polymeric material comprises a film formed from polycarbonate. In certain embodiments, Applicant's polymeric material comprises a film formed from plasticized polyvinylchloride (“PVC”).

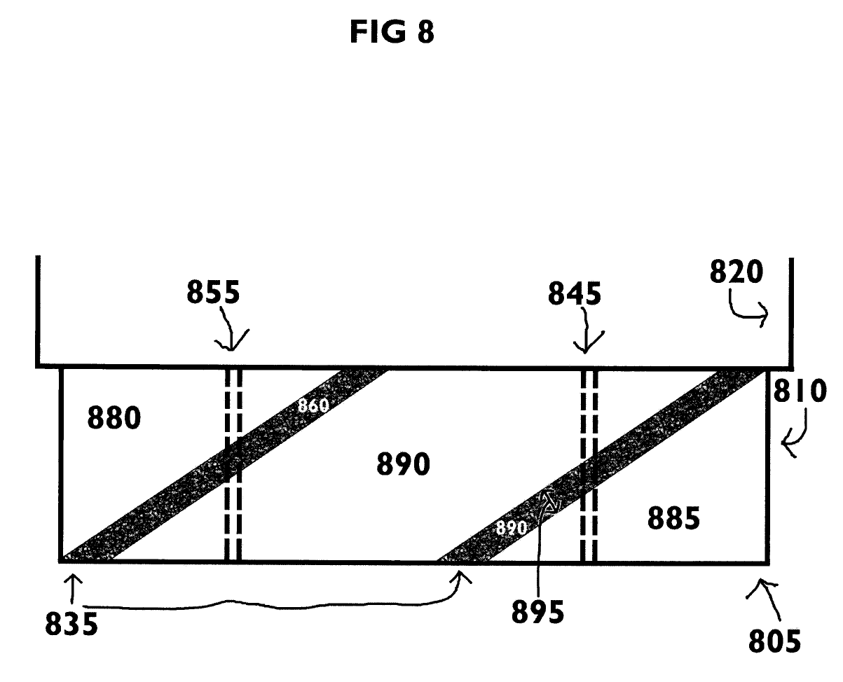

Examples III and IV show that an entire exposed foundation need not be completely treated with an epoxy coating in order to resist the reappearance of termite tunnels. In other embodiments, Applicants' method to dispose a termite barrier on an exposed foundation includes selectively treating that exposed foundation with an epoxy coating. For example and referring now to FIG. 8, in this embodiment of Applicants' method to form a termite barrier foundation 810 of building 805 is selectively treated with an epoxy coating, such that portions 860 and 870 of foundation 810 are treated but portions 880, 885, and 890, are not treated with the epoxy coating. Applicant has found that diagonally treated sections of a foundation which include a vertical component, such as vertical component 895, of at least 6 inches in height, such diagonal treatment effectively resists subsequent termite invasions.

### Example V

Applicant has further found that wood comprising Applicants' termite barrier treatment appears to be of little interest to termites. Because the wood is effectively sealed within an airtight hardened armor, termites appear to have little interest in attempting to bore through it. For example, one surface of a wooden member was treated using a two part epoxy system sold in commerce under the tradename 2000 RESIN by Resin Research, Inc. to form a coating over the entire surface. That wooden member was placed on termite-infested soils with the coated surface in contact with those termite-infested soils. After 18 months exposure to termite-infested soils, the coated surface showed no termite tunneling or other termite damage.

As a control, a separate wooden member was not treated with an epoxy coating. That untreated wooden member was placed in contact with the termite-infested soils adjacent the treated wooden member. After 18 months exposure to termite-infested soils, the untreated member showed a plurality of termite tunnels disposed over every surface thereof.

In certain embodiments of Applicant's invention, Applicant's epoxy coating is combined with one or more of the termite poisons described above. In the event termites attempt to bore through Applicants' barrier, then the incorporated one or more termite poisons will resist such termite invasion.

In Examples I, II, III, IV, and V, Applicant used an epoxy formulation comprising a two-part system, where that system included a resin component and a hardener component. The only equipment needed was a mixing cup and a stirring rod.

Thus for use in Applicants' method, the epoxy formulation of Examples I and II can be effectively formulated within a wide range of component ratios. As those skilled in the art will appreciate, use of such an epoxy formulation in other applications may not be so ratio insensitive. For example, if 2000 RESIN were used in a structurally demanding application, then such an application would require more accurate weighing of the resin and hardener components.

The use of 2000 RESIN is only one exemplary epoxy system. Applicant has found that other two part epoxy systems are equally effective. Such two part epoxy systems can be safely used by homeowners even without special equipment. Because such a system does not include any solvents, much less one or more volatile solvents, no respiratory protection is required. Furthermore, because the resin component and the hardener components are relatively non-toxic, no other particular personal protective equipment, such as for example, chemical gloves, lab coats, lab aprons, or the like, is required. As those skilled in the art will appreciate, safety glasses are always recommended when using/applying ANY chemical formulation.

In addition, once the resin and hardener are combined, the resulting epoxy reaction mixture comprises a viscosity which is easy to apply using a paint brush. That viscosity gradually increases over an hour or longer.

Applicant has further determined that other chemical coatings may be effectively used. Regardless of the coating formulation utilized, that formulation can be clear or pigmented.

When using RESIN 2000 in Examples I II, III, IV, and V, above, Applicant employed the process of Example VI.

### Example VI

The two parts are mixed in a cup or bucket until the two components are fully dispersed into each other. Using a paintbrush, foam brush, small roller or spraying system the resin/hardener mixture is applied to the lower 6-10 inches of the building. The material is applied to the foundation from ground level up to and slightly around the point where the structure containing wooden construction materials begins.

In other embodiments, Applicants' termite barrier is applied, during construction, to all lower areas of wooden construction to deter termite infestation. In certain embodiments, Applicants' termite barrier is also be applied, as described herein, to the inner and/or outer surfaces of the foundation during construction. In addition, Applicant's termite barrier fills voids and cracks in the foundation which further resists termite invasions.

### Example VII

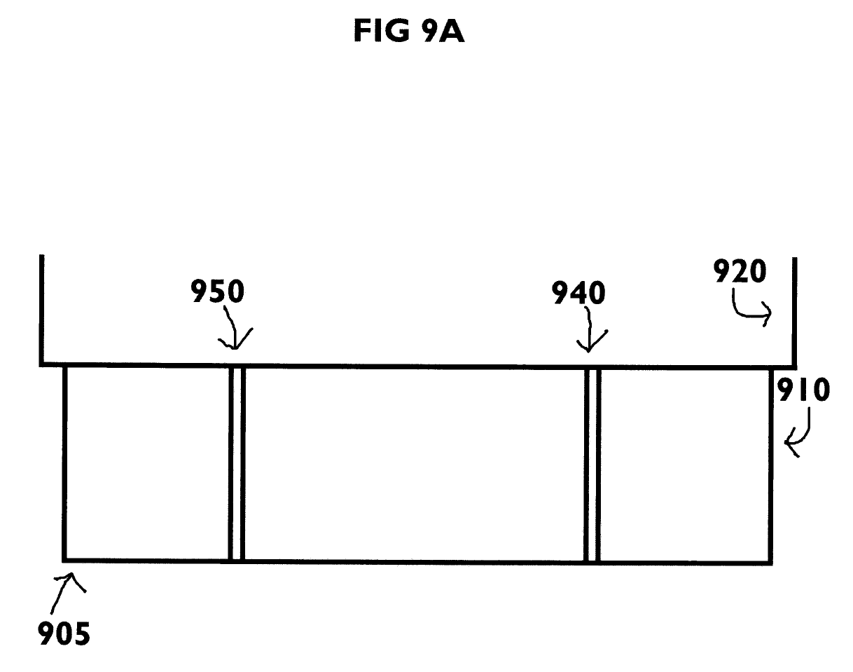

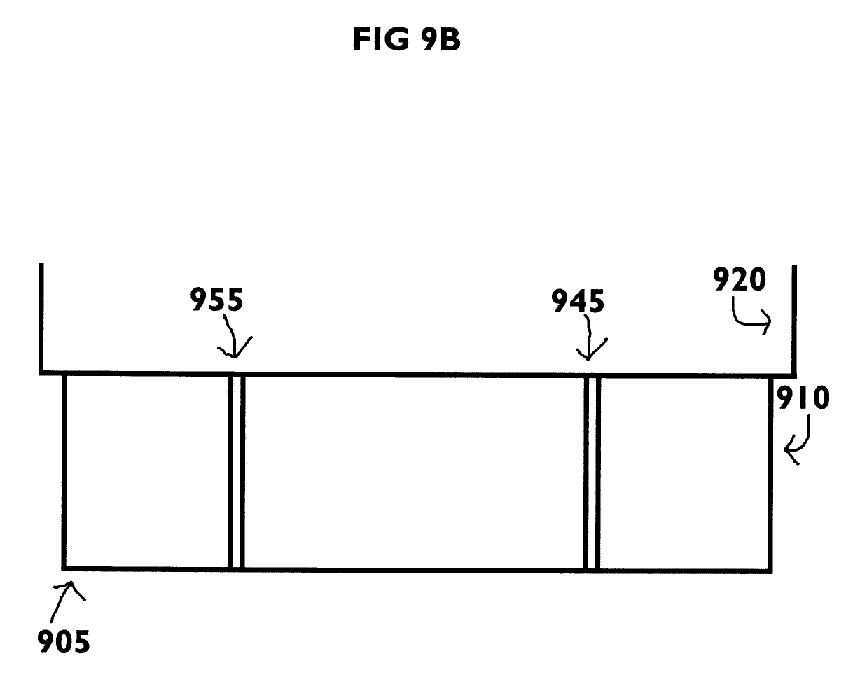

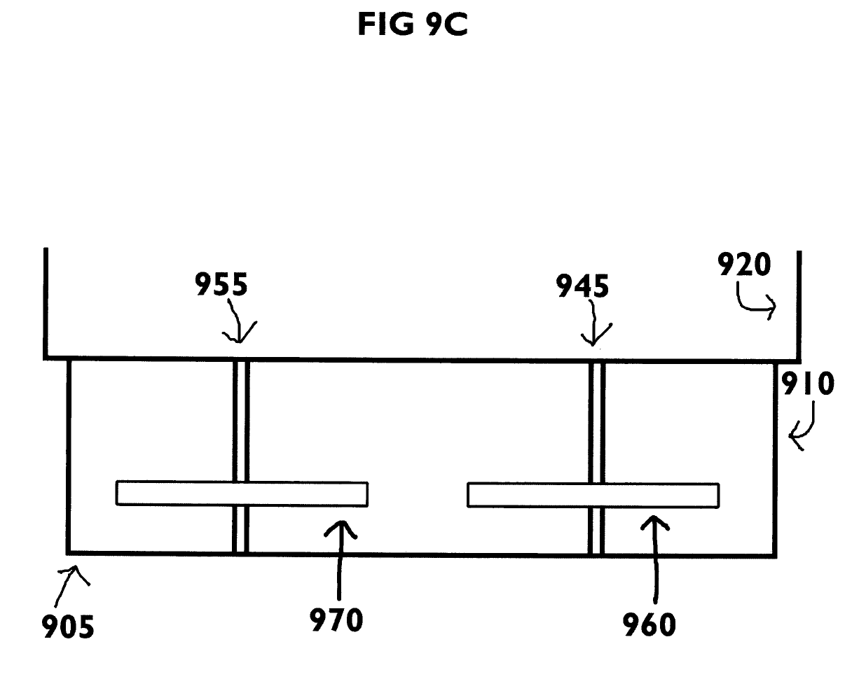

In this Example VII, Applicant again utilized his method to effectively treat a building suffering from a termite infestation. Referring to FIG. 9A, building 905 includes foundation 910 and structure 920. Before beginning the study of Example VII, two termite tunnels, namely tunnels 940 and 950 were observed.

Referring to FIG. 9B, on day 1 of the study termite tunnels 940 (FIG. 9A) and 950 (FIG. 9A) were removed from foundation 910 by mechanically destroying those tunnels. Portion 945 comprises that portion of foundation 510 onto which termite tunnel 940 was previously disposed. Portion 955 comprises that portion of foundation 910 onto which termite tunnel 950 was previously disposed.

Referring now to FIG. 9C, further on day 1 of study of this Example VII, Applicant horizontally applied polymeric material 960 across about a two (2) inch portion of former termite tunnel area 945. In addition, Applicant horizontally applied polymeric material 970 across about a two (2) inch portion of former termite tunnel area 955.

In certain embodiments of this Example VII, polymeric material 960 and polymeric material 970 comprised a film of polyvinylchloride (“PVC”) having an adhesive disposed on one side. The adhesive-bearing sides of the PVC films 960 and 970 were adhered to the surface of foundation 910. In these PVC film embodiments, polymeric materials 960 and 970 comprised a product sold in commerce by Heinkel Consumer Adhesives, Inc. under the name CRYSTAL CLEAR.

Applicant has found that after sixty (60) days, no termite tunnels have been rebuilt across polymeric material 960 or 970.

### Example VIII

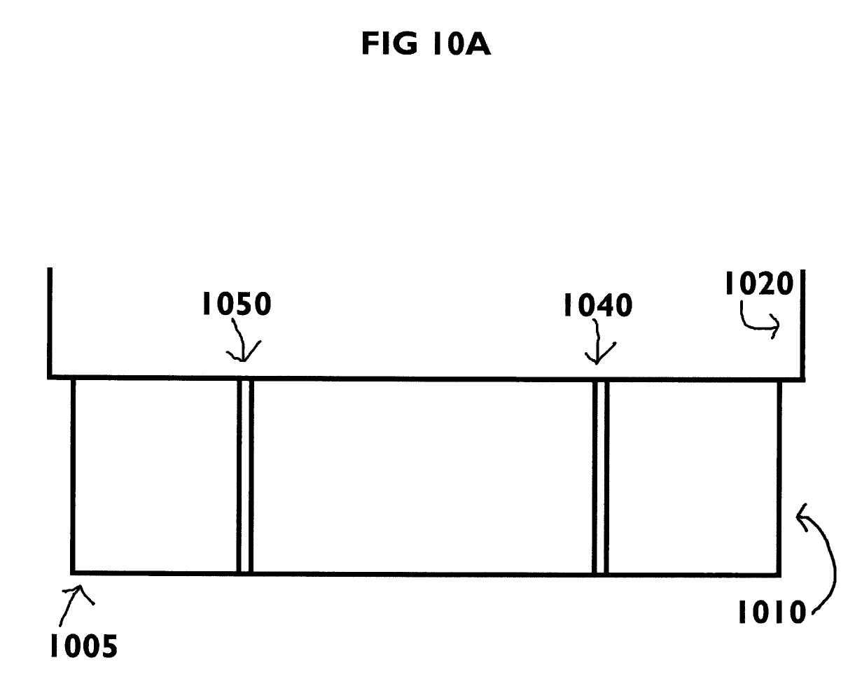

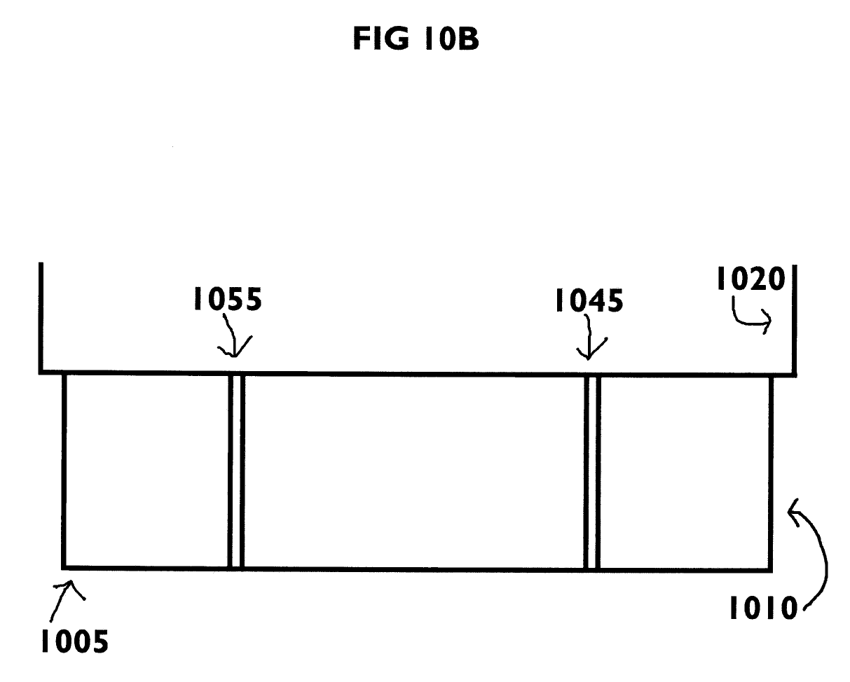

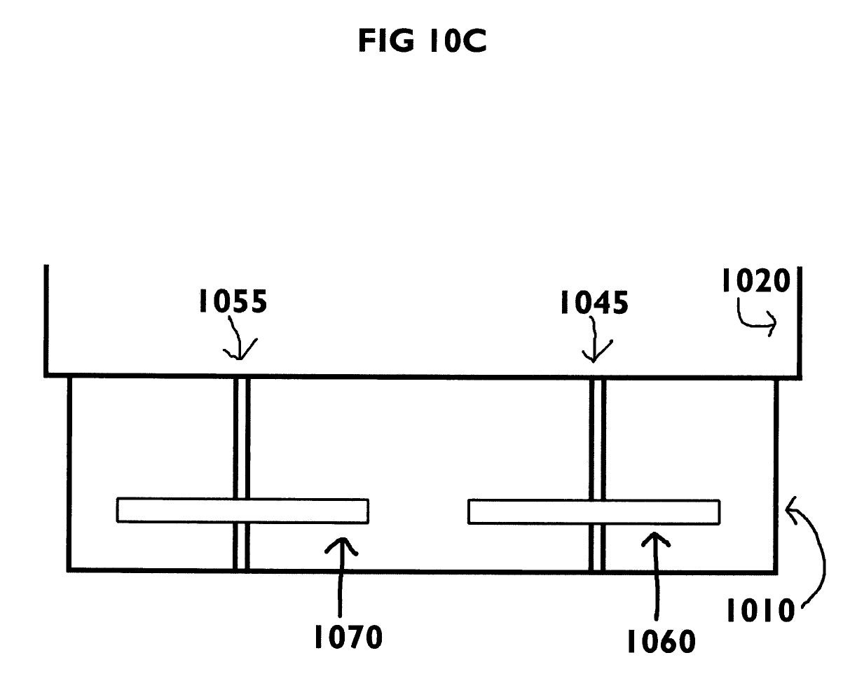

In this Example VIII, Applicant utilized cloth tapes to attempt to treat a building suffering from a termite infestation. Referring to FIG. 10A, building 1005 includes foundation 1010 and structure 1020. Before beginning the study of Example VIII, two termite tunnels, namely tunnels 1040 and 1050 were observed.

Referring to FIG. 10B, on day 1 of the study termite tunnels 1040 (FIG. 10A) and 1050 (FIG. 10A) were removed from foundation 1010 by mechanically destroying those tunnels. Foundation portion 1045 comprises that portion of foundation 1010 onto which termite tunnel 1040 was previously disposed. Portion 1055 comprises that portion of foundation 1010 onto which termite tunnel 1050 was previously disposed.

Referring now to FIG. 10C, further on day 1 of study of this Example VIII, Applicant horizontally applied material 1060 across about a two (2) inch portion of former termite tunnel area 1045. In addition, Applicant horizontally applied material 1070 across about a two (2) inch portion of former termite tunnel area 1055.

Material 1060 and material 1070 comprised a cloth tape having an adhesive disposed on one side. The adhesive-bearing sides of the cloth tapes 1060 and 1070 were adhered to the surface of foundation 1010. Applicant observed, however, that termite tunnels were rebuilt across cloth tapes 1060 and 1070 within about one (1) day.

### Example IX

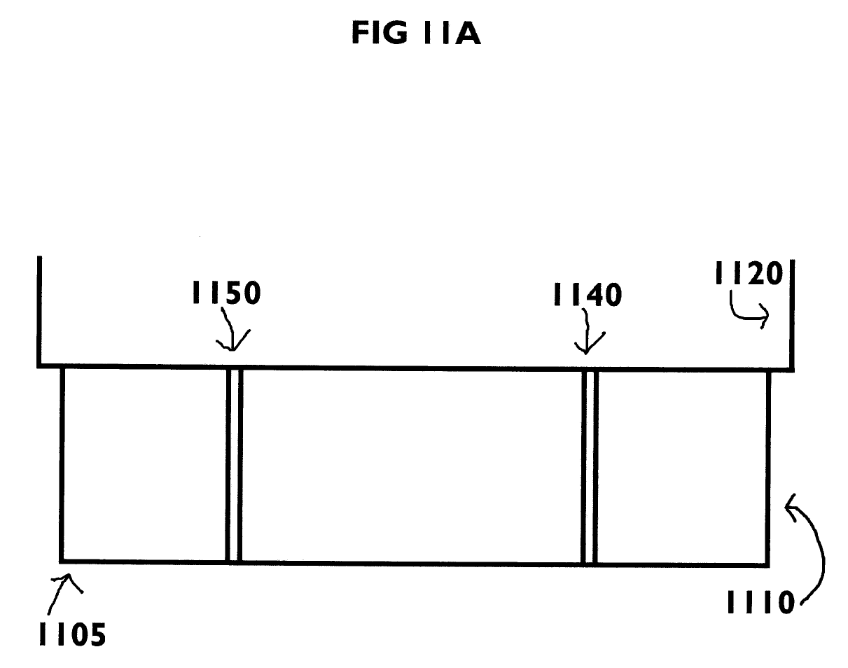

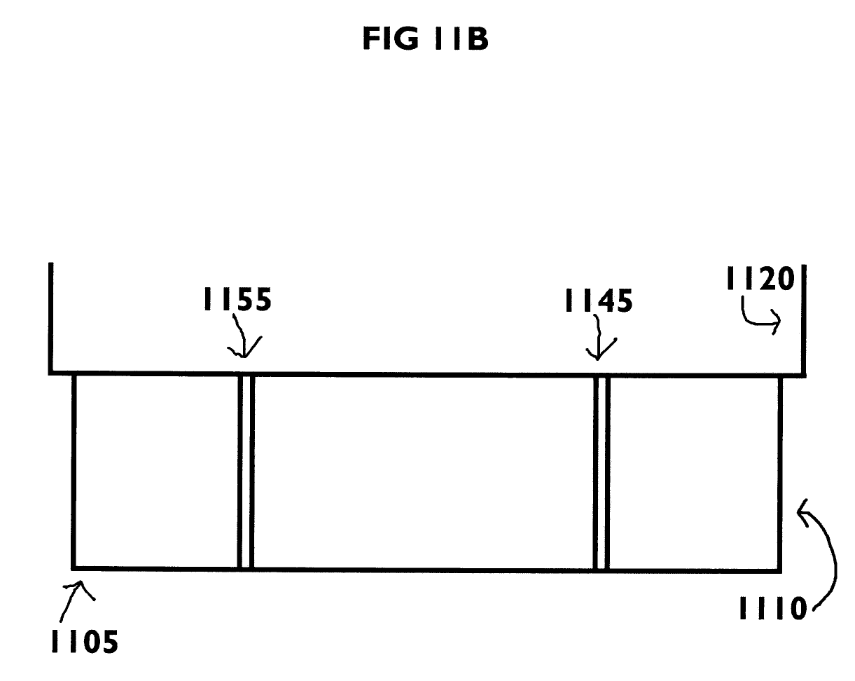

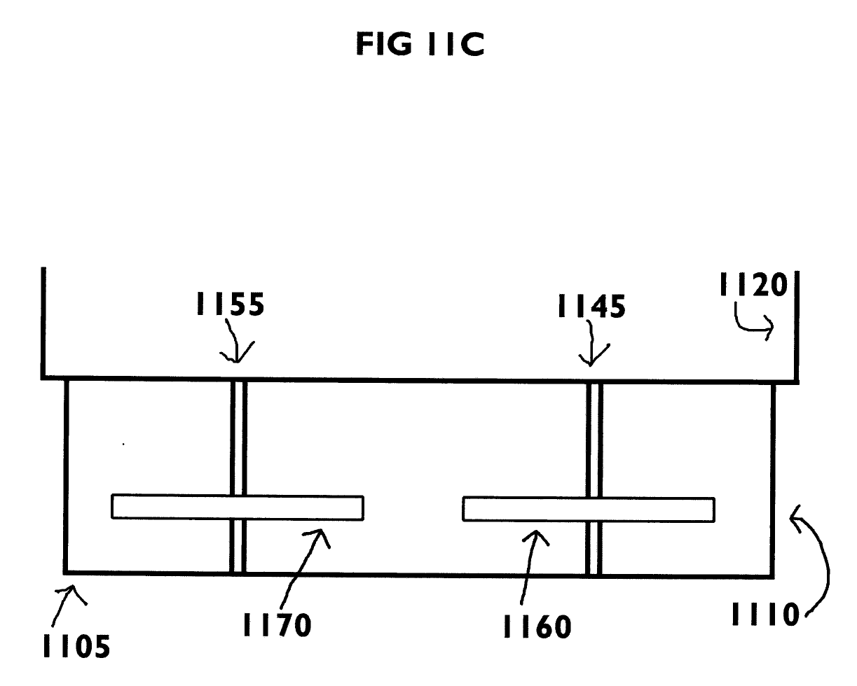

In this Example IX, Applicant utilized polyurethane coated cloth tapes to attempt to treat a building suffering from a termite infestation. Referring to FIG. 11A, building 1105 includes foundation 1110 and structure 1120. Before beginning the study of Example IX, two termite tunnels, namely tunnels 1140 and 1150 were observed.

Referring to FIG. 11B, on day 1 of the study termite tunnels 1140 (FIG. 11A) and 1150 (FIG. 11A) were removed from foundation 1110 by mechanically destroying those tunnels. Foundation portion 1145 comprises that portion of foundation 1110 onto which termite tunnel 1140 was previously disposed. Portion 1155 comprises that portion of foundation 1110 onto which termite tunnel 1150 was previously disposed.

Referring now to FIG. 11C, further on day 1 of study of this Example IX, Applicant horizontally applied material 1160 across about a two (2) inch portion of former termite tunnel area 1145. In addition, Applicant horizontally applied material 1170 across about a two (2) inch portion of former termite tunnel area 1155.

Material 1160 and material 1170 comprised a cloth tape having an adhesive disposed on one side and a polyurethane disposed on the opposing second side. The adhesive-bearing sides of the cloth tapes 1160 and 1170 were adhered to the surface of foundation 1110. Applicant observed, however, that termite tunnels were rebuilt across cloth tapes 1160 and 1170 within about one (1) day.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to treat a termite infestation in a building, wherein said building comprises a structure and a foundation, wherein said foundation comprises an exposed portion in contact with soil and extending upwardly to said structure, and wherein one or more termite tunnels are disposed on said exposed portion, comprising the steps of:
supplying a polymeric material;
removing said one or more termite tunnels from said exposed portion;
disposing said polymeric material horizontally across said exposed portion of said foundation over the former termite tunnel locations;
wherein said polymeric material comprises a surface roughness Amplitude Parameter Ra of 32 microinches or less.

2. The method of claim 1, wherein said supplying a polymeric material comprises supplying a polyvinylchloride film.

3. The method of claim 1, wherein said supplying a polymeric material comprises supplying an epoxy resin.

4. The method of claim 1, wherein said supplying a polymeric material comprises supplying a film formed from low density polyethylene.

5. The method of claim 1, wherein said polymeric material does not comprise an insecticide or a termiticide.

6. The method of claim 5, wherein said polymeric material comprises a surface roughness Amplitude Parameter Ra of 16 microinches or less.

7. The method of claim 6, wherein said polymeric material comprises a surface roughness Amplitude Parameter Ra of 8 microinches or less.

8. The method of claim 7, wherein said polymeric material comprises a surface roughness Amplitude Parameter Ra of 4 microinches or less.

9. The method of claim 8, wherein said polymeric material comprises a surface roughness Amplitude Parameter Ra of 2 microinches or less.

10. The method of claim 5, wherein said polymeric material comprises a film formed from an amorphous polymer.

11. A method to deter a termite infestation in a building, wherein said building comprises a structure and a foundation, wherein said foundation comprises an exposed portion in contact with soil and extending upwardly to said structure, and wherein one or more termite tunnels are disposed on said exposed portion, comprising the steps of:
supplying a polymeric material, wherein said polymeric material does not consist of a cloth tape or a cloth tape comprising a polyurethane coating;
disposing said polymeric material horizontally on said exposed portion of said foundation;
wherein said polymeric material comprises a surface roughness Amplitude Parameter Ra of 32 microinches or less.

12. The method of claim 11, wherein said supplying a polymeric material comprises supplying a polyvinylchloride film.

13. The method of claim 11, wherein said supplying a polymeric material comprises supplying an epoxy resin.

14. The method of claim 11, wherein said supplying a polymeric material comprises supplying a film formed from low density polyethylene.

15. The method of claim 11, wherein said polymeric material does not comprise an insecticide or a termiticide.

16. The method of claim 15, wherein said polymeric material comprises a surface roughness Amplitude Parameter Ra of 16 microinches or less.

17. The method of claim 16, wherein said polymeric material comprises a surface roughness Amplitude Parameter Ra of 8 microinches or less.

18. The method of claim 17, wherein said polymeric material comprises a surface roughness Amplitude Parameter Ra of 4 microinches or less.

19. The method of claim 18, wherein said polymeric material comprises a surface roughness Amplitude Parameter Ra of 2 microinches or less.

20. The method of claim 15, wherein said polymeric material comprises a film formed from an amorphous polymer.
